(19) United States
(12) Patent Application Publication
(10) Pub. No.: US 2008/0082315 A1
(43) Pub. Date: Apr. 3, 2008

(54) Translation evaluation apparatus, translation evaluation method and computer program

(75) Inventors: Sayori SHIMOHATA, Osaka (JP); Miki SASAKI, Osaka (JP); Mihoko KITAMURA, Kyoto (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/902,578

(22) Filed: Sep. 24, 2007

(30) Foreign Application Priority Data
Sep. 29, 2006 (JP) 2006-269940

(51) Int. Cl. G06F 17/28

(52) U.S. Cl. 704/2

(57) ABSTRACT

A translation evaluation apparatus is includes: a parallel translation corpus data base (310) that stores, in an associated manner, base original texts and respective model translated texts of the base original texts, a parallel translation linking unit (225) that links the model translated texts to create a linked model translated text, and links the base original texts that are associated with the model translated texts that form the linked model translated text to create a linked original text; an evaluation target translated text input unit (110) that is used to input evaluation target translated text and that corresponds with the base original text; and an evaluation value computation unit (235) that links the evaluation target translated text to create a linked evaluation target translated text, and compares the linked evaluation target translated text and the linked model translated text to evaluate the translation quality of the evaluation target translated text.

### CROSS REFERENCE TO RELATED APPLICATIONS

The disclosure of Japanese Patent Application No. JP 2006-269940 filed on Sep. 29, 2006 is incorporated herein by reference in its entirety.

### BACKGROUND OF THE INVENTION

1. Field of the Invention

The present invention relates to a translation evaluation apparatus, a translation evaluation method, and a computer program. More specifically, the invention relates to a translation evaluation apparatus, a translation evaluation method and a computer program that automatically evaluate the adequacy of a translated text that is translated by a human translator, a machine translation system or the like, or the translation capability of a human or a machine translation system or the like.

2. Description of the Related Art

There is a need to quantitatively and effectively measure the translation capability of human translators or machine translation systems or the quality of translations produced thereby. To address this need, methods have been proposed such as an evaluation method in which an evaluation use text is translated and the result subjectively evaluated by an evaluator, and an evaluation method in which the evaluation is performed automatically and objectively by a machine.

An example of the evaluation method that performs evaluation using a subjective evaluator is described in, for example, non-patent literature, “Solutions to Problems Inherent in Spoken-language Translation: The ATR-MATRIX Approach” by Sumita, E et al. in Proc. MT Summit VII pp. 229-235 (1999). In this evaluation method, the evaluator gives subjective rankings like A, B, C, D or the like in accordance with evaluation criteria that are determined in advance. For example, the ranks may be defined in the following manner. A translated text that has no mistakes in terms of both information and grammar is given an A rank (perfect), a translated text that is easy to understand but that has missing non-important information or grammar weaknesses is given a B rank (average), a translated text that is incomplete but just understandable is given a C rank (permissible), and a translated text in which important information is wrongly translated is given a D rank (unintelligible).

On the other hand, one example of the evaluation method that performs evaluation automatically and objectively using a machine is a digitized numerical method in which a machine (program) compares the translation result that is to be evaluated with a correct translated text (a reference text), and then computes the closeness of the texts, which is used to generate a digitized numerical value for the translation quality of the evaluated text. In a method like this, the total or the average of the digitized numerical translation quality is computed to output an overall evaluation value.

For example, non-patent literature “BLEU: A Method for Automatic Evaluation of Machine Translation” by Kishore Papineni, Salim Roukos, Todd Ward, and Wei-Jing Zhu in Proceedings of ACL-2002, pp. 311-318 (2002), describes use of an evaluation metric BLEU. The evaluation metric BLEU uses Equation 1 or Equation 2 below to compute the closeness of the evaluation text that is to be evaluated and the reference text based on the number of n-grams that match. Here, the term n-gram indicates a sequence of n consecutive items. For example, a word n-gram is a sequence of n consecutive words, or a character n-gram is a character sequence made up of n characters.

$$\begin{matrix}BLEU = {BP}_{BLEU} \times exp ( {\sum }_{n = 1}^{N} {w}_{n} log {p}_{n} ) & Equation 1 \\ {p}_{n} = \frac{{\sum }_{i} ( \begin{matrix}the number of n - grams in segment i , \\ in the translation being evaluated , with \\ a matching reference cooccurrence \\ in segment i\end{matrix} )}{{\sum }_{i} ( \begin{matrix}the number of n - grams in segment i , \\ in the translation being evaluated\end{matrix} )} & Equation 2\end{matrix}$$

pₙ is a score that is computed as the ratio of n-gram matches that is obtained by comparing translated texts with reference texts for an evaluation corpus that stores a plurality of paired translated texts and reference texts. Here, the score is computed using a geometric average for 1-gram to N-gram. N is normally 4. In addition, 1-gram is a metric that indicates the degree of accuracy of the word translation, and a high order n-gram indicates the degree of fluency of the translation. The BLEU score that is expressed by Equation 1 is a metric that combines both of the above. Note that, BP_{BLEU} is a penalty that is applied when the translated text is shorter than the reference text. In the case that the translated text is longer than the reference text it is 1, and in the case that the translated text and the reference text is the same length or shorter, it is e^{(1-r/c)} (r is the reference text length, c is the translated text length). In this manner, the BLEU score is indicated by a real number, namely, 0 to 1. It is determined that the translation is better as the value increases.

In addition, for example, non-patent literature “Automatic Evaluation of Machine Translation Quality using n-gram Co-occurrence Statistics” by George Doddington in Proceedings of the HLT Conference, San Diego, Calif. (2002), describes use of an evaluation metric NIST score. In a similar manner to the above described BLEU score, the NIST score indicates the closeness of the translated text that is to be evaluated and the reference text, and is computed using Equation 3 and Equation 4 below based on the number of matching n-grams.

$$\begin{matrix}{BP}_{NIST} \times {\sum }_{n = 1}^{N} \frac{{\sum }_{i} ( {\sum }_{{w}_{1} … {w}_{n} common to the translaioned texts and the reference texts} Info ( {w}_{1} … {w}_{n} ) )}{{\sum }_{i} ( \begin{matrix}the number of n - grams in segment i , \\ in the translation being evaluated\end{matrix} )} & Equation 3 \\ Info ( {w}_{1} … {w}_{n} ) = {log}_{2} \frac{the number of occurrences of {w}_{1} … {w}_{n - 1}}{the number of occurrence of {w}_{1} … {w}_{n}} & Equation 4\end{matrix}$$

The NIST score is represented by a real number of 0 or more. It is determined that the translation is better as the value increases. N is normally 5. Note that, BP_{NIST} is, like BP_{BLEU}, 1 when the length of the translated text is longer than the reference text. The main difference between NIST and BLEU is that a weight is given to each n-gram based on an information amount. Generally, because the information amount is higher for a content word sequence than a functional word sequence, NIST has a tendency to give a higher score in the case that the translation of content words is correct. In this manner, the NIST score is an automatic evaluation score that focuses more on accuracy of word translations than on accuracy of word order.

However, evaluations methods that use the subjective perspective of an evaluator to perform evaluation are highly dependent on the evaluator in terms of time and quality. Moreover, setting of the evaluation metric is difficult, and even if the same evaluation metric is used as a basis for evaluation, the evaluation result obtained by different evaluators tends to vary.

On the other hand, although automatic and objective evaluation methods that use a machine are outstanding in terms of objectivity, but are faced by the difficulty of how to easily prepare example texts used for evaluation and the corresponding model translations. More particularly, in the known methods, if the number of constituent words of the translated text is few (for example, the number of constituent words is less than 10), there tends to be substantial variation in the evaluation results. Thus, unless the text is reasonable long, it is not possible to compute a correct evaluation value. For example, in “BLEU: A Method for Automatic Evaluation of Machine Translation” described above, it is normal that N equals 4, and in “Automatic Evaluation of Machine Translation Quality using n-gram Co-occurrence Statistics” described above, it is normal that N equals 5. In the case that the number of constituent words is equal to or less than these values, it is not possible to compute the evaluation. In reality, if the number of words is not a number of times N, it is not possible to obtain an appropriate evaluation.

### SUMMARY OF THE INVENTION

The present invention has been devised in light of the above-described problems, and it is objects thereof to provide a new and innovative translation evaluation apparatus, translation evaluation method and a computer program that automatically evaluate the quality of a translated text regardless of the length of the translated text while inhibiting variation in evaluation results.

In order to address the above-described problems, a first aspect of the present invention provides a translation evaluation apparatus that evaluates the quality of a translated text that is a translation of an original text. The translation evaluation apparatus includes a parallel translation storage unit that stores, in an associated manner, base original texts that are used as a basis for translation evaluation, and respective model translated texts of the base original texts. Further, the translation evaluation device also includes: a parallel translation linking unit that links at least one of the model translated texts to create a linked model translated text, and links the base original texts that are associated with the model translated texts that form the linked model translated text to create a linked original text; an evaluation target translated text input unit that is used to input at least one evaluation target translated text that is to be evaluated and that corresponds with the base original text; and a translation evaluation unit that links the at least one evaluation target translated text that is associated with the base original texts that form the linked original text to create a linked evaluation target translated text, and compares the linked evaluation target translated text and the linked model translated text to evaluate the translation quality of the evaluation target translated text.

Moreover, in order to address the above-described problems, another aspect of the present invention provides a translation evaluation method that evaluates the quality of a translated text that is a translation of an original text. The translation evaluation method includes a parallel translation linking step in which at least one model translated text of a base original text is linked to create a linked model translated text, the at least one model translated text being stored in association with respective base original texts that are used as a basis for translation evaluation in a parallel translation storage unit, and in which the base original texts associated with the model translated texts that form the linked model translated text are linked to create a linked original text. Further, the method also includes: an evaluation target translated text input step in which at least one evaluation target translated text that is to be evaluated and that correspond with the base original text is input; a linked evaluation target translated text creation step in which at least one evaluation target translated text that is associated with the base original texts that form the linked original text is linked to create a linked evaluation target translated text; and a translation evaluation step in which the translation quality of the evaluation target translated text is evaluated by comparing the linked evaluation target translated text and the linked model translated text.

In order to address the above-described problems, another aspect of the present invention provides a computer program that comprises instructions that command a computer to function as a translation evaluation apparatus that evaluates the quality of a translated text that is a translation of an original text. The computer program includes: a parallel translation storage module that stores, in an associated manner, base original texts that are used as a basis for translation evaluation, and respective model translated texts of the base original texts; a parallel translation linking module that links at least one of the model translated texts to create a linked model translated text, and links the base original texts that are associated with the model translated texts that form the linked model translated text to create a linked original text; an evaluation target translated text input module that is used to input at least one evaluation target translated text that is to be evaluated and that correspond with the base original text; and a translation evaluation module that links the at least one evaluation target translated text that is associated with the base original texts that form the linked original text to create a linked evaluation target translated text, and compares the linked evaluation target translated text and the linked model translated text to evaluate the translation quality of the evaluation target translated text.

The above-described invention provides a translation evaluation apparatus, a translation evaluation method and a computer program that can automatically evaluate the quality of a translated text regardless of the length of the translated text while inhibiting variation in evaluation results.

### BRIEF DESCRIPTION OF THE DRAWINGS

FIG. 1 is a block diagram that shows the configuration of a translation evaluation apparatus according to a first embodiment of the present invention;

FIG. 2 is an explanatory figure that illustrates a concrete example of the structure of a parallel translation corpus data base;

FIG. 3 is an explanatory figure that illustrates a concrete example of the structure of a translated text evaluation data base;

FIG. 4 is an explanatory figure that illustrates a concrete example of the structure of an evaluation use memory;

FIG. 5 is a flow chart that shows a creation process that creates the translated text evaluation data base according to the first embodiment;

FIG. 6 is a flow chart that shows an evaluation value computation process for an evaluation target translated text according to the first embodiment;

FIG. 7 is a block diagram that shows the configuration of a translation evaluation apparatus according to a second embodiment of the present invention; and

FIG. 8 is a flow chart that shows an evaluation value computation process for an evaluation target translated text according to the second embodiment.

### DETAILED DESCRIPTION OF THE PREFERRED EMBODIMENTS

Hereinafter, preferred embodiments of the present invention will be described in detail with reference to the appended drawings. Note that, in this specification and the drawings, structural elements that have substantially the same function and structure are denoted with the same reference numerals, and repeated explanation of these structural elements is omitted.

### First Embodiment

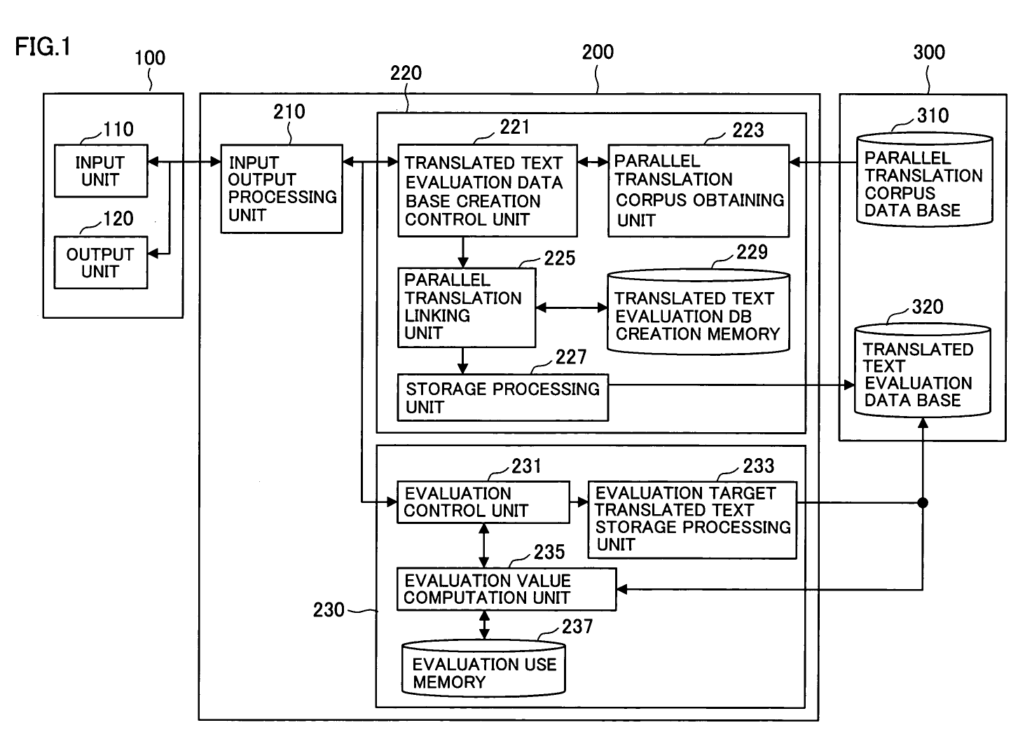

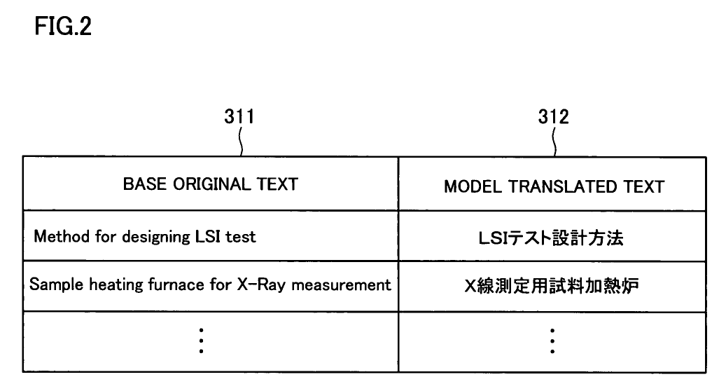

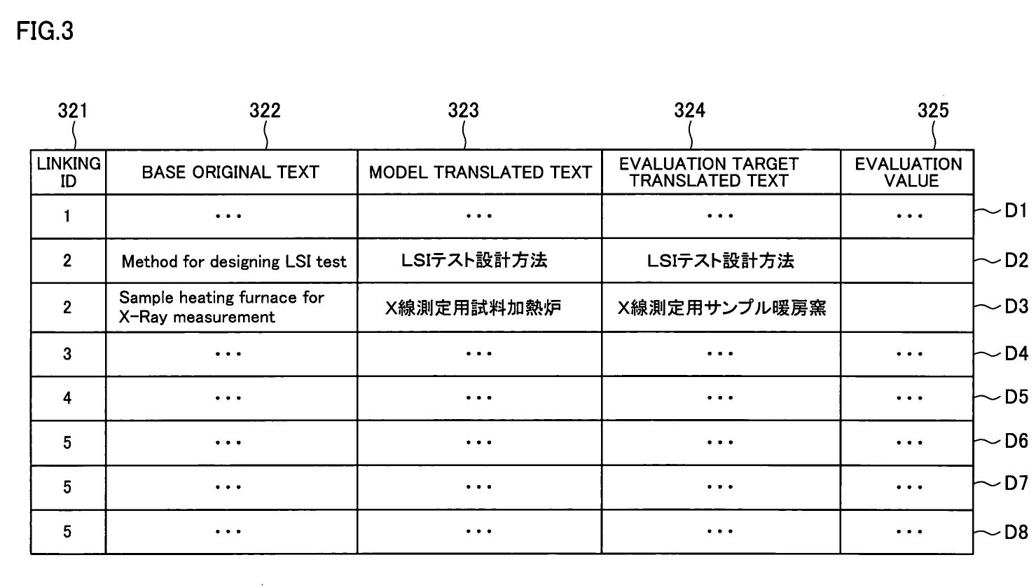

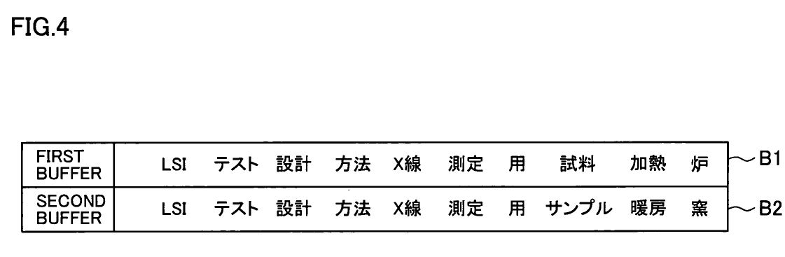

First, a translation evaluation apparatus according to the first embodiment of the present invention will be explained with reference to FIG. 1 to FIG. 4. Note that, FIG. 1 is a block diagram that shows the configuration of the translation evaluation apparatus according to the first embodiment of the present invention. FIG. 2 is an explanatory figure that illustrates a concrete example of the structure of a parallel translation corpus data base 310. FIG. 3 is an explanatory figure that illustrates a concrete example of the structure of a translated text evaluation data base 320. FIG. 4 is an explanatory figure that illustrates a concrete example of the structure of an evaluation use memory 237.

Structure of the Translation Evaluation Apparatus

The translation evaluation apparatus according to the present embodiment, as shown in FIG. 1, includes an input output device 100, an evaluation processing device 200, and a storage device 300. The input output device 100 includes an input unit 110 and an output unit 120. The input unit 110 is a functional part that is used for inputting an evaluation target translated text, an instruction or the like that is transmitted to the evaluation processing device 200. The input unit 110 may be, for example, a keyboard, a pointing device such as a mouse, a scanner, or a microphone. The output unit 120 is a functional part for outputting data for an image, a sound or the like that is received from the evaluation processing device 200. The output unit 120 may be, for example, a display device, or a speaker.

The evaluation processing device 200 is a device that evaluates the quality of the evaluation target translated text that is input from the input output device 100, and includes an input output processing unit 210, a translated text evaluation data base creation processing unit 220, and an evaluation processing unit 230. The input output processing unit 210 is a functional part that exchanges information with the input output device 100, the translated text evaluation data base creation processing unit 220, and the evaluation processing unit 230.

The translated text evaluation data base creation processing unit 220 is a functional part that creates the translated text evaluation data base 320, described later, and includes a translated text evaluation data base creation control unit 221, a parallel translation corpus obtaining unit 223, a parallel translation linking unit 225, a storage processing unit 227, and a translated text evaluation DB creation memory 229.

The translated text evaluation data base creation control unit 221 is a functional part that controls each functional part that is used for creating the translated text evaluation data base 320, described later. The translated text evaluation data base creation control unit 221 uses a creation instruction for the translated text evaluation data base 320 that is input from the input unit 110 of the input output device 100 as a basis for controlling the parallel translation corpus obtaining unit 223 described later to obtain pairs of respective base original texts and model translated texts stored in the parallel translation corpus data base 310. In addition, once the translated text evaluation data base creation processing unit 220 has received the paired base original text and model translated text from the parallel translation corpus obtaining unit 223, the paired base original text and model translated text are transmitted to the parallel translation linking unit 225, described later.

The parallel translation corpus obtaining unit 223 is a functional part that obtains the paired base original text and model translated text stored in the parallel translation corpus data base 310 described later. The parallel translation corpus obtaining unit 223 obtains the paired translation texts, namely, the base original text and the model translated text stored in the parallel translation corpus data base 310, based on the instruction from the translated text evaluation data base creation control unit 221, and then transmits the obtained paired translation texts to the translated text evaluation data base creation control unit 221.

The parallel translation linking unit 225 is a functional part that assigns a linking ID to the base original text and the model translated text. The linking ID is an ID that is assigned to determine the evaluation target translated text that is to be linked when the evaluation processing unit 230, described later, evaluates the quality of the evaluation target translated text. Whether or not to perform linking of the evaluation target translated text is determined based on the length of a linked evaluation target translated text that is formed by linking the evaluation target translated text. Accordingly, the parallel translation linking unit 225 is provided with an estimation unit (not shown) that estimates the length of the model translated text in order to be able to assign a linking ID to the base original text and the model translated text. The estimation unit of the parallel translation linking unit 225 according to the present embodiment estimates the number of constituent words that form the model translated text.

The storage processing unit 227 is a functional part that links the linking ID assigned by the parallel translation linking unit 225 to the paired base original text and model translated text obtained by the parallel translation corpus obtaining unit 223, and stores this information in the translated text evaluation data base 320.

The translated text evaluation DB creation memory 229 is a storage unit that temporarily stores computed information when the parallel translation linking unit 225 assigns the linking ID to the paired base original text and the model translated text. The translated text evaluation DB creation memory 229 includes, for example, a RAM, a flash memory or the like. The translated text evaluation DB creation memory 229 stores information like the minimum length of an evaluation target translated text that is evaluated at one time by the evaluation processing unit 230, a maximum linking ID that is the maximum value of the linking ID that is required when assigning a linking ID, and the present length of the evaluation target translated text to which the maximum linking ID is assigned.

The evaluation processing unit 230 is a functional part that evaluates the quality of the evaluation target translated text input from the input output device 100, and includes an evaluation control unit 231, an evaluation target translated text storage processing unit 233, an evaluation value computation unit 235, and the evaluation use memory 237 etc.

The evaluation control unit 231 is a functional part that controls all of the functional parts in order to evaluate the evaluation target translated text. The evaluation control unit 231 receives the base original text input from the input output device 100 and the evaluation target translated text that is a translation of the base original text. In addition, the evaluation control unit 231 controls the evaluation target translated text storage processing unit 233, described after, to store the evaluation target translated text in the translated text evaluation data base 320. Moreover, the evaluation control unit 231 controls the evaluation value computation unit 235 to compute the evaluation value of the evaluation target translated text stored in the translated text evaluation data base 320.

The evaluation target translated text storage processing unit 233 is a functional part that stores the evaluation target translated text received from the evaluation control unit 231 in the translated text evaluation data base 320. When the evaluation target translated text storage processing unit 233 receives the base original text and the evaluation target translated text from the evaluation control unit 231, the evaluation target translated text storage processing unit 233 matches the base original text already stored in the translated text evaluation data base 320 and the base original text received from the evaluation control unit 231, and stores the evaluation target translated text in the translated text evaluation data base 320 in correspondence with the matched base original text of the translated text evaluation data base 320.

The evaluation value computation unit 235 is a functional part that evaluates the quality of the translation. The evaluation value computation unit 235 compares the evaluation target translated text stored in the translated text evaluation data base 320 and the corresponding model translated text to compute an evaluation value that indicates the quality of the translation. Note that, the computation method for computing the evaluation value used by the evaluation value computation unit 235 will be described in more detail later. In addition, the evaluation value computation unit 235 transmits the computed evaluation value to the input output device 100 via the evaluation control unit 231 and the input output processing unit 210.

The evaluation use memory 237 is a storage unit that temporarily stores a linked model translated text and a linked evaluation target translated text. The evaluation use memory 237 may be, for example, a RAM, a flash memory or the like. The evaluation use memory 237, as shown in FIG. 4, stores a first buffer B1 that stores the linked model translated text that links model translated texts that have the same linking ID, and a second buffer B2 that stores the linked evaluation target translated text that links the evaluation target translated texts that have the same linking ID.

The storage device 300 includes the parallel translation corpus data base 310 and the translated text evaluation data base 320. The parallel translation corpus data base 310 is a storage unit that stores a plurality of parallel translations that are linked pairs of corresponding base original texts and model translated texts. The parallel translation corpus data base 310 may be, for example, a memory like a RAM, a hard disk or the like. The parallel translation corpus data base 310, as shown in FIG. 2, stores a base original text 311 that is written in a first language, a model translated text 312 that is a translation of the base original text that has been translated into a second language, and the like.

The translated text evaluation data base 320 is a storage unit that stores information that is necessary for evaluating the evaluation target translated text, and may be, for example, a memory like a RAM, a hard disk or the like. The translated text evaluation data base 320, as shown in FIG. 3, stores, for example, a linking ID 321 that indicates base original texts, model translated texts that have been translated into a second language from the base original texts and an evaluation target translated text that are to be linked, a base original text 322, a model translated text 323, an evaluation target translated text 324, and an evaluation value 325 for the evaluation target translated text of each linking ID.

The input output device 100, the evaluation processing device 200, and the storage device 300 that structure the above described translation evaluation device may be formed as separate apparatuses or may be formed as a single apparatus.

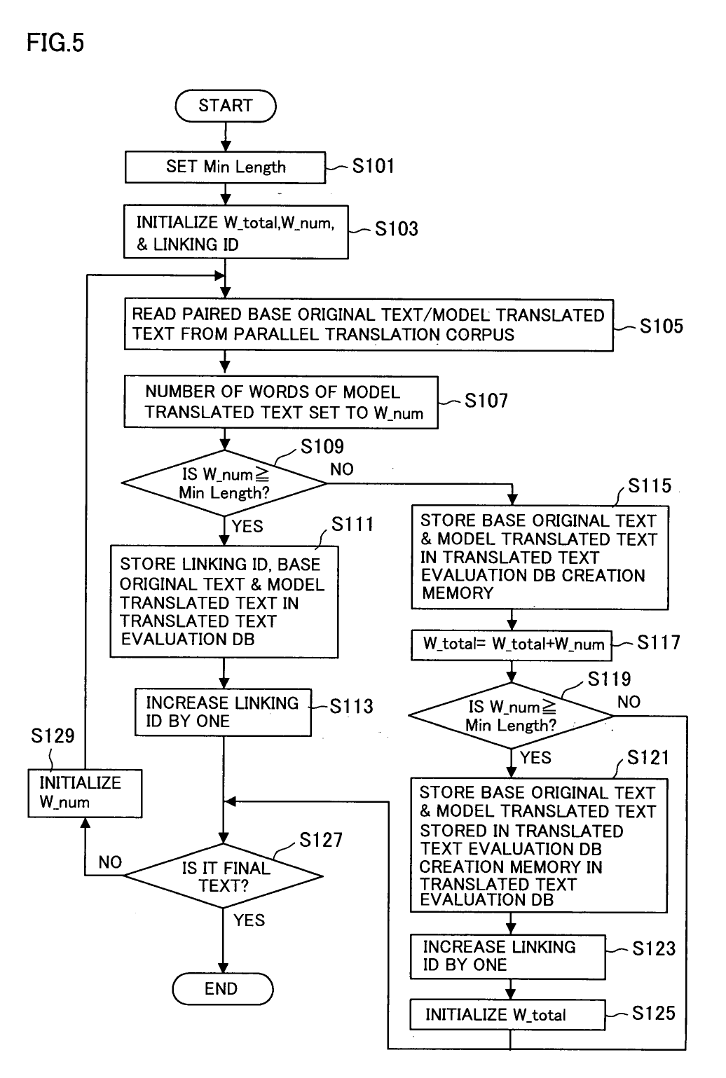

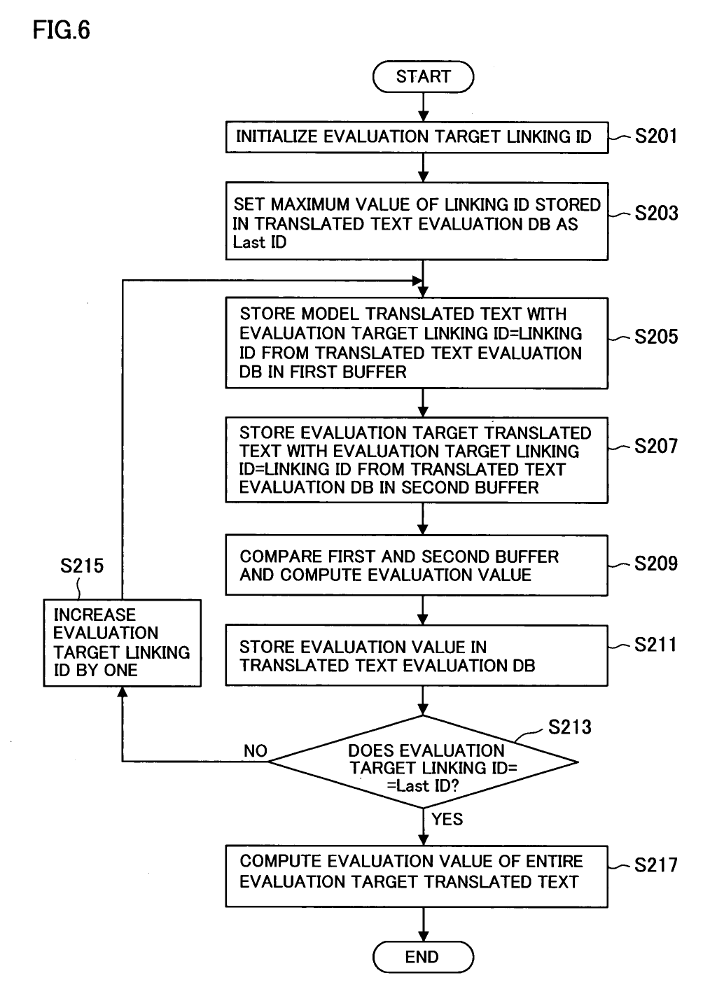

Hereinabove, the translation evaluation apparatus according to the present embodiment has been explained. Before evaluating the evaluation target translated text, first, the described translation evaluation apparatus creates the translated text evaluation data base 320, and then computes the evaluation value for the evaluation target translated text. Next, FIG. 5 and FIG. 6 will be used to explain a creation process that creates the translated text evaluation data base 320 and an evaluation value computation process that computes an evaluation value for the evaluation target translated text according to the present embodiment. Note that, FIG. 5 is a flow chart that shows the creation process of the translated text evaluation data base 320, and FIG. 6 is a flow chart that shows the evaluation value computation process for the evaluation target translated text.

Creation Process of the Translated Text Evaluation Data Base

The creation process of the translated text evaluation data base 320 is mainly performed by the translated text evaluation data base creation processing unit 220. A key feature of the present embodiment is creating, in order to inhibit variation in the evaluation results of the translation, the linked evaluation target translated text that has a determined number of constituent words or more by linking evaluation target translated texts when computing the evaluation value. More specifically, the creation process of the translated text evaluation data base 320 is a process that is performed to create the information necessary for determining the evaluation target translated texts that are to be linked.

In the creation process of the translated text evaluation data base 320, first, as shown in FIG. 5, a minimum length of the linked model translated text is set (step S101). As described above, in order to appropriately evaluate the evaluation target translated text, it is necessary for the evaluation target translated text to have a reasonable length. Thus, in the evaluation value computation process, the Min Length is set as the minimum length that it is regarded as necessary for the model translated text to have. More specifically, the length of the model translated text is specified in terms of the number of words that constitute the model translated text. For example, the Min Length of the number of words that constitute the linked model translated text may be set as 10.

Next, W_total that is the cumulative number of words of the number of words that constitute the linked model translated text, W_num that is the number of words that constitute a single model translated text, and the linking ID that indicates the model translated texts to be linked are initialized (step S103). For example, in the initial state, the cumulative number of words W_total may be set to 0, the number of constituent words W_num may be set to 0, and the linking ID may be set to 1.

Next, the pair of texts, namely, the base original text and the corresponding model translated text, are read from the parallel translation corpus data base 310 as specified by the translated text evaluation data base creation control unit 221 (step S105). Then, the number of constituent words W_num of the read model translated text is set (step S107). For example, at step S105, as shown in FIG. 2 for example, the base original text “Method for designing LSI test” and the corresponding model translated text “LSI [symbol] may be read. At this time, the model translated text includes four constituent words, namely, “LSI”, [symbol] and [symbol] . Accordingly, at step S107, 4 is set for the number of constituent words W_num. Note that, counting of the constituent words is performed by separating the constituent words of model translated text using, for example, morphological analysis, and counting the number of constituent words.

Next, it is determined if the number of constituent words of the model translated text read at step S105 is equal to or more than a determined number (step S109). In the present embodiment, this determination is performed by comparing the Min Length set at step S101 and W_num set at step S107. For example, if the model translated text read at step S105 is “LSI [symbol] it is determined that the number of constituent words is less than the Min Length (equals 10), because the number of constituent words W_num is 4.

If the number of constituent words W_num of the single model translated text is equal to or more than the Min Length, the present linking ID, the base original text and the corresponding model translated text are stored in the linking ID 321, the base original text 322, and the model translated text 323 of the translated text evaluation data base 320 (step S111). Then, after increasing the linking ID by just one (step S113), step S127 is performed.

On the other hand, if the number of constituent words W_num of the single model translated text is less than the Min Length, the base original text and the model translated text in this case are stored in the translated text evaluation DB creation memory 229 (step S115). Then, the sum of the number of constituent words W_num of the single model translated text and the present cumulative number of words W_total is set as the cumulative number of words W_total (step S117). Next, it is determined whether the cumulative number of words W_total is equal to or more than a determined number, namely, Min Length (step S119).

For example, in the case where the base original text “Method for designing LSI test” and the model translated text “LSI [symbol] are read at step S105 (the number of constituent words W_num equals 4), it is assumed that the cumulative number of words W_total is 0. In this case, first, the base original text “Method for designing LSI test” and the model translated text “LSI [symbol] are stored in the translated text evaluation DB creation memory 229. Next, at step S117, the cumulative number of words W_total is set to 4, namely, the sum of the number of constituent words W_num (equals 4) and the present cumulative number of words W_total (equals 0). Following this, at step S119, it is determined whether the cumulative number of words W_total (equals 4) is equal to or more than the Min Length (equals 10) (this processing state is referred to as “processing state 1”).

If the cumulative number of words W_total is equal to or more than the Min Length at step S119, the linking ID, the base original text and the corresponding model translated text stored in the translated text evaluation DB creation memory 229 are stored in the linking ID 321, the base original text 322, and the model translated text 323 of the translated text evaluation data base 320 (step S121). In this case, a plurality of base original texts stored in the translated text evaluation DB creation memory 229 are referred to as a linked original text, and a plurality of model translated texts are referred to as a linked model translated text. Accordingly, all pairs of base original texts and model translated texts stored in the translated text evaluation DB creation memory 229 are assigned the same linking ID. Following this, the linking ID is increased by just one (step S123), and the cumulative number of words W_total is initialized (step S125). The cumulative number of words W_total may be, for example, initialized to one. Then, step S127 is performed.

On the other hand, if the cumulative number of words W_total is less than the Min Length, following step S119, step S127 is performed. For example, because the processing state 1 described above fits this case, the translated text evaluation DB creation memory 229 is left in the same state, and step S127 is performed (this processing state is referred to as “processing state 2”).

At step S127, it is checked whether there are any unread parallel translations that have not been read from the parallel translation corpus data base 310 (step S127). If all of the parallel translations have been read from the parallel translation corpus data base 310 and stored in the translated text evaluation data base 320, then the present processing routine is ended. On the other hand, if there are unread parallel translations, the number of constituent words W_num is initialized (step S129), and then the processing from step S105 is repeated. The number of constituent words W_num may be, for example, initialized to 0.

For example, following the above-described processing state 2, the number of constituent words W_num may be initialized to 0 at step S129, and the base original text “Sample heating furnace for X-ray measurement” and the model translated text “X [symbol] shown in FIG. 2 are read at step S105. At this time, the model translated text includes 6 constituent words, namely, “X [symbol] [symbol] Accordingly, at step S107, the number of constituent words W_num is set to 6. As a result, it is determined at step S109 that the number of constituent words W_num (equals 6) is smaller than the Min Length (equals 10).

Next, the processing at step S115 is performed in which the base original text “Sample heating furnace for X-ray measurement” and the model translated text “X [symbol] are stored in the translated text evaluation DB creation memory 229. At this time, two base original texts, namely, “Method for designing LSI test” and “Sample heating furnace for X-ray measurement” are stored in the linking original text storage region of the translated text evaluation DB creation memory 229, and two model translated text, namely, “LSI [symbol] and “X [symbol] [symbol] are stored in a linking model translated text storage region. Then, at step S117, the sum of the cumulative number of words W_total (equals 4) and the cumulative number of words W_num (equals 6) is set as the new cumulative number of words W_total (equals 10).

Following this, at step S119, the respective magnitudes of the new cumulative number of words W_total (equals 10) and the Min Length (equals 10) are compared, and because the two values are equal, the processing of step S121 is performed. More specifically, the paired base original text “Method of designing LSI test” and model translated text “LSI [symbol] , and the paired base original text “Sample heating furnace for X-ray measurement” and model translated text “X [symbol] [symbol] are stored in the translated text evaluation data base 320. At this time, the same linking ID is assigned to each paired text. For example, if the present linking ID is 2, the linking ID “2” is assigned to the two pairs.

Next, at step S123, the linking ID is increased by just one to 3, and then at step S125, the cumulative number of words W_total and the linking original text storage region and the linking model translated text storage region in the translated text evaluation DB creation memory 229 are initialized.

Hereinabove, the creation process of the translated text evaluation data base 320 according to the present embodiment has been explained. As a result of the above processing, among the storage fields of the translated text evaluation data base 320 shown in FIG. 3, the linking ID 321, the base original text 322, and the model translated text 323 are set. As described above, the linking ID of the translated text evaluation data base 320 indicates the base original text and model translated text that are to be linked. Next, the evaluation value computation process that computes the evaluation value of the evaluation target translated text that is to be evaluated using the created translated text evaluation data base 320 will be explained.

Evaluation Value Computation Process for the Evaluation Target Translated Text

The evaluation value computation process for the evaluation target translated text is mainly performed by the evaluation processing unit 230. At this time, the linking ID 321, the base original text 322, and the model translated text 323, and the evaluation target translated text 324 are already stored in the translated text evaluation data base 320. The evaluation target translated text 324 may be set, for example, by storing an input evaluation target translated text in the following manner. A base original text and a corresponding evaluation target translated text are input from the input unit 110 of the input output device 100, and the base original text 322 stored in the translated text evaluation data base 320 and the input base original text are matched, thereby allowing the input evaluation target translated text to be stored in the translated text evaluation data base 320.

In the evaluation value computation process for the evaluation target translated text, as shown in FIG. 6, first, the evaluation target linking ID stored in the evaluation use memory 237 is initialized (step S201). Then, the maximum value of the linking ID stored in the translated text evaluation data base 320 is set as Last_ID (step S203). For example, the evaluation target linking ID is set to “1” at step S201, and the Last_ID is set to “5” at step S203.

Next, the model translated text that has the linking ID that is the same as the evaluation target linking ID is extracted from the translated text evaluation data base 320, and stored in the evaluation use memory 237 (step S205). The extracted model translated text, as shown in FIG. 4, for example, is stored in the first buffer B1 of the evaluation use memory 237 as the linking model translated text. In the same way, the evaluation target translated text that has the linking ID that is the same as the evaluation target linking ID is extracted from the translated text evaluation data base 320, and stored in the evaluation use memory 237 (step S207). The extract evaluation target translated text, as shown in the example of FIG. 4, is stored as the linking evaluation target translated text in the second buffer B2 of the evaluation use memory 237.

For example, if the present evaluation target linking ID equals 2, among the data stored in the translated text evaluation data base 320 shown in FIG. 3, data for which the evaluation target linking ID equals the linking ID equals 2 is data D2 and data D3. Accordingly, as shown in FIG. 4, the linked model translated text, namely, the linked model translated text of data D2 and the model translated text of data D3, is stored in the first butter B1 of the evaluation use memory 237, and the linked evaluation target translated text, namely, the linked evaluation target translated text of data D2 and the evaluation target translated text of data D3, is stored in the second buffer B2 of the evaluation use memory 237.

Next, the linked model translated text stored in the first buffer B1 of the translated text evaluation DB creation memory 229 and the linked evaluation target translated text stored in the second buffer B2 of the translated text evaluation DB creation memory 229 are compared, and the evaluation value for the linked evaluation target translated text stored in the second buffer B2 is computed (step S209). The evaluation value computed at step S209 may be computed by a known evaluation value computation method. For the evaluation value computation method, a known method like that described in “BLEU: A Method for Automatic Evaluation of Machine Translation” or “Automatic Evaluation of Machine Translation Quality using n-gram Co-occurrence Statistics” or the like may be used. The evaluation value computed at step S209 is stored in the evaluation value 325 of the translated text evaluation data base 320 (step S211).

Next, it is determined whether the present evaluation target linking ID is equal to Last_ID (step S213). If it is determined that the evaluation target linking ID and the Last_ID are the same, the evaluation value of the entire evaluation target translated text stored in the translated text evaluation data base 320 is computed (step S217). On the other hand, if it is determined that the present evaluation target linking ID and the Last_ID are different, the evaluation target linking ID is increased by just one, and the evaluation target linking ID stored in the evaluation use memory 237 is updated (step S215). Then, the processing of step S205 and the following steps is repeated.

Hereinabove, the evaluation value computation process of the evaluation target translated text according to the present embodiment has been explained. A key feature of the present embodiment is using the linking ID assigned by the creation process of the translated text evaluation data base 320 to create the linked model translated text and the linked evaluation target translated text, and computing the evaluation value with respect to the created linked model translated text and the linked evaluation target translated text. As a result, because the translation to be evaluated has a length that is always equal to or more than a determined length, it is possible to inhibit variation in the evaluation result.

Hereinabove, the translation evaluation apparatus and the translation evaluation method according to the first embodiment have been explained. According to the translation evaluation apparatus of the first embodiment, before evaluating the evaluation target translated text, the length of the model translated text is taken into consideration. If the length of the translated text is short, the parallel translation linking unit 225 links model translated texts to create a linked model translated text that is equal to or more than a determined length. As a result, the parallel translation corpus can be used to automatically create the linked original text and the linked model translated text that are required for automatic evaluation. In addition, the linked model translated text and the corresponding linked evaluation target translated text are compared to compute the evaluation value. Accordingly, it becomes possible for the evaluation value to be computed even using a translated text that is too short, and reliability of the evaluation value can be inhibited from becoming low.

### Second Embodiment

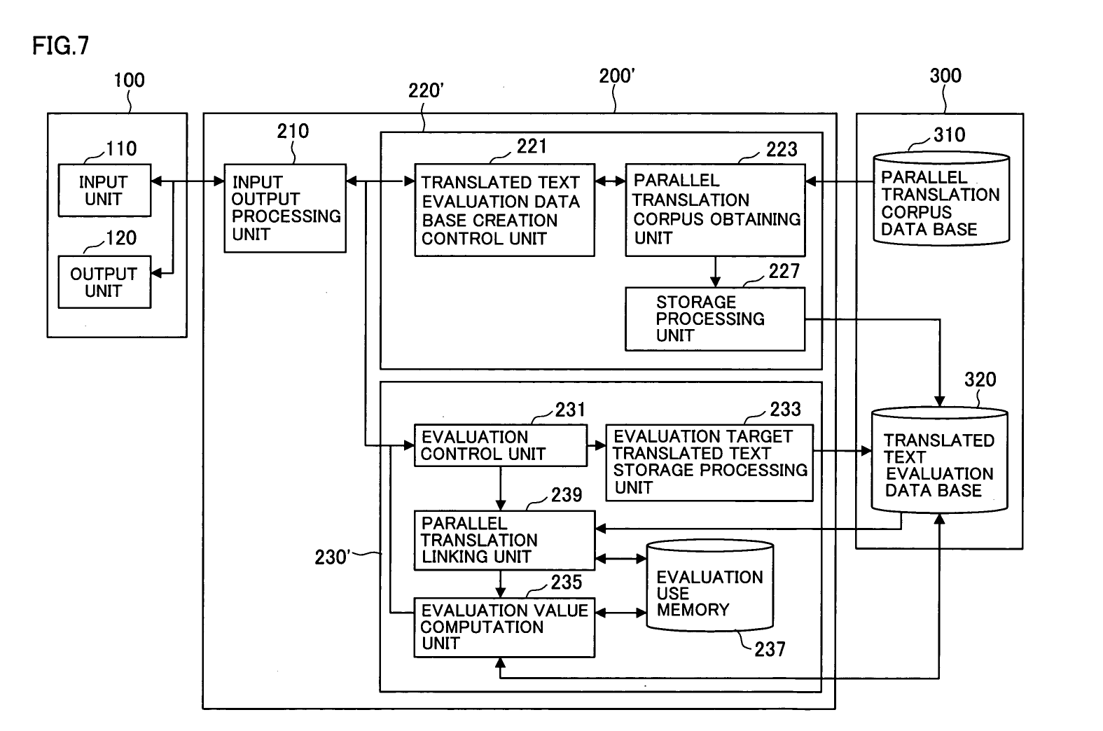

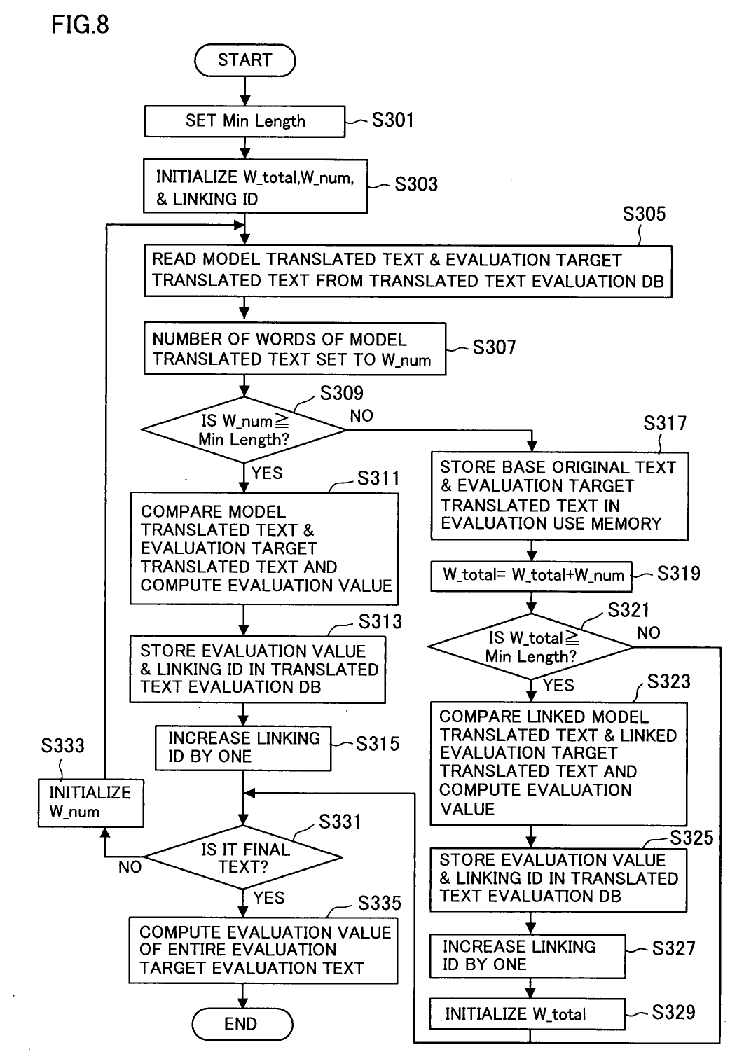

Next, FIG. 7 and FIG. 8 will be used as a basis for explaining a translation evaluation apparatus according to a second embodiment of the present invention. Note that, FIG. 7 is a block diagram that shows the configuration of the translation evaluation apparatus according to the second embodiment of the present invention, and FIG. 8 is a flow chart that shows an evaluation value computation process for an evaluation target translated text according to the second embodiment. Also, note that, in the following description, a detailed explanation of structural members and processes that are the same as those in the first embodiment will be omitted.

The translation evaluation apparatus according to the second embodiment differs from the translation evaluation apparatus according to the first embodiment in that the parallel translation linking unit that measures the length of the model translated text and assigns the linking ID to the paired base original text and the model translated text is provided in the evaluation processing unit 230. More specifically, a translated text evaluation data base creation processing unit 220′ that forms part of an evaluation processing device 200′ includes the translated text evaluation data base creation control unit 221, the parallel translation corpus obtaining unit 223, and the storage processing unit 227, and an evaluation processing unit 230′ includes the evaluation control unit 231, the evaluation target translated text storage processing unit 233, the evaluation value computation unit 235, the evaluation use memory 237, and the parallel translation linking unit 239. The function of each of these units is the same as the respective unit of the first embodiment, and thus a repeated explanation will be omitted here. Hereinafter, the evaluation value computation process of the translation evaluation apparatus according to the second embodiment will be explained.

The translated text evaluation data base creation processing unit 220′ performs processing that stores the base original text and the model translated text in the translated text evaluation data base 320. The parallel translation corpus obtaining unit 223 obtains paired base original texts and model translated text from the parallel translation corpus data base 310, based on creation of the translated text evaluation data base by the translated text evaluation data base creation control unit 221. Then, the storage processing unit 227 stores the base original texts and the model translated texts in the translated text evaluation data base 320.

The evaluation processing unit 230′ links the base original texts, the model translated texts and the evaluation target translated texts stored in the translated text evaluation data base 320, and evaluates the evaluation target translated texts. First, if the base original text and the evaluation target translated text that is the corresponding translated text are input from the input output device 100, the base original text stored in the translated text evaluation data base 320 and the input base original text are matched, and the evaluation target translated text is stored in the translated text evaluation data base 320. Then, the parallel translation linking unit 239 and the evaluation value computation unit 235 are used to compute the evaluation value of the evaluation target translated text.

In the computation process of the evaluation value for the evaluation target translated text according to the second embodiment, as shown in FIG. 8, first, the minimum length of the linked model translated text is set (step S301). Next, the cumulative number of words W_total of the constitute words that form the linked model translated text, the number of constituent words W_num that is the number of words that constitute a single model translated text, and the linking ID that indicates the translated texts to be linked are initialized (step S303). Steps S301, S303 are the same as steps S101 and S103 according to the first embodiment.

Next, the paired model translated text and evaluation target translated text are read from the translated text evaluation data base 320 (step S305). Then, from among the read translated texts, the number of constituent words W_num that form the model translated text is set (step S307). Next, it is determined if the number of constituent words of the model translated text read at step S305 is equal to or more than the determined number (step S309).

If the number of constituent words W_num of the single model translated text is equal to or more than the Min Length, the model translated text read at step S305 and the evaluation target translated text are compared, and the evaluation value of the evaluation target translated text is computed (step S311). The evaluation value computed at step S311 may be computed using a known evaluation value computation method. Next, the evaluation value computed at step S311 is stored in the evaluation value 325 of the translated text evaluation data base 320 (step S313). At this time, the linking ID is also stored in the translated text evaluation data base 320. Following this, after increasing the linking ID by just one (step S315), step S331 is performed.

On the other hand, if the number of constituent words W_num of the single model translated text is less than Min Length, the model translated text and the evaluation target translated text in this case are stored in the evaluation use memory 237 (step S317). Then, the sum of the number of constituent words W_num of the single model translated text and the present cumulative number of words W_total is set as the cumulative number of words W_total (step S319). Next, it is determined whether the cumulative number of words W_total is equal to or more than a determined number, namely, the Min Length (step S321).

If the cumulative number of words W_total is equal to or more than Min Length at step S321, the linked model translated text that is obtained by linking model translated texts stored in the evaluation use memory 237 and the linked evaluation target translated text that is obtained by linking evaluation target translated texts stored in the evaluation use memory 237 are compared, thereby allowing computation of the evaluation value of the evaluation target translated text (step S323). Then, the evaluation value computed at step S323 is stored in the evaluation value 325 of the translated text evaluation data base 320 (step S325). At this time, the liking ID is also stored in the translated text evaluation data base 320. Following this, the linking ID is increased by just one (step S327), and the cumulative number of words W_total is initialized (step S329). Then, step S331 is performed.

On the other hand, if the cumulative number of words W_total is less than Min Length, following step S321, step S331 is performed.

At step S331, it is checked whether all of the data stored in the translated text evaluation data base 320 has been evaluated (step S331). If all of the data has been evaluated, then the evaluation value of the entire evaluation target translated text is computed, and the processing is ended (step S335). On the other hand, if there is data for which the evaluation value has not yet been computed, the number of constituent words W_num is initialized (step S333), and then the processing from step S305 is repeated.

In the manner described above, once the evaluation value for the evaluation target translated text is computed, the evaluation value computation unit 235 outputs the evaluation value from the output unit 120 of the input output device 100 via the input output processing unit 210.

Hereinabove, the translation evaluation apparatus and the translation evaluation method according to the second embodiment have been described. According to the translation evaluation apparatus of the second embodiment, before evaluating the evaluation target translated text, the length of the model translated text is taken into consideration. If the length of the translated text is short, the parallel translation linking unit 239 links model translated texts to create a linked model translated text that is equal to or more than a determined length. As a result, the parallel translation corpus can be used to automatically create the linked model translated text and the linked evaluation target translated text that is required for automatic evaluation. In addition, the linked model translated text and the corresponding linked evaluation target translated text are compared to compute the evaluation value. Accordingly, it becomes possible for the evaluation value to be computed even when using a translated text that is too short, and reliability of the evaluation value can be inhibited from becoming low.

Hereinabove, preferred embodiments of the present invention have been described while referring to the appended drawings. However, as will be readily apparent, the present invention is not limited to the described examples. It will be clear to those skilled in the art that various modifications, combinations, sub-combinations and alterations may be made within the scope of the appended claims or the equivalents thereof. It is to be understood that such modifications, combinations, sub-combinations and alterations are taken to be within the technical scope of the present invention.

For example, in the above embodiments, the constituent number of words that form the model translated text is measured by the measurement unit of the parallel translation linking unit. However, the present invention is not limited to this example. For example, the number of characters of the model translated text, or the number of times a specific word appears within the constituent words that form the model translated text may be measured.

Further, in the above embodiments, the Min Length of the length of the translated text that is to be linked is a fixed value. However, the present invention is not limited to this example. For example, Min Length may be computed using the expression, Min Length=N×X (where X is a chosen number), such that there is a link with N (N is the word or the number of characters that is the unit of evaluation) of Equation 1 or Equation 3 used when computing the evaluation value. Alternatively, Min Length may be automatically changed based on a link with a specific value that is set in the expression used for computing the evaluation value for the evaluation target translated text.

What is claimed is:

1. A translation evaluation apparatus that evaluates the quality of a translated text that is a translation of an original text, comprising:
a parallel translation storage unit that stores, in an associated manner, base original texts that are used as a basis for translation evaluation, and respective model translated texts of the base original texts;
a parallel translation linking unit that links at least one of the model translated texts to create a linked model translated text, and links the base original texts that are associated with the model translated texts that form the linked model translated text to create a linked original text;
an evaluation target translated text input unit that is used to input at least one evaluation target translated text that is to be evaluated and that corresponds with the base original text; and
a translation evaluation unit that links the at least one evaluation target translated text that is associated with the base original texts that form the linked original text to create a linked evaluation target translated text, and compares the linked evaluation target translated text and the linked model translated text to evaluate the translation quality of the evaluation target translated text.

2. The translation evaluation apparatus according to claim 1, wherein
the parallel translation linking unit comprises:
a measurement unit that measures the length of each of the model translated texts; and
a linking ID assigning unit that assigns a single linking ID to the model translated texts that form the linked model translated text, the linking ID being the same for each model translated text in the linked model translated text, wherein
the linking ID assigning unit assigns the linking ID to the model translated texts such that the linked model translated text has a length that is equal to or more than a determined length.

3. The translation evaluation apparatus according to claim 2, further comprising:
a translation evaluation storage unit that stores, in an associated manner, the base original text, the model translated texts of the base original text, the evaluation target translated texts of the base original text, and the linking ID.

4. The translation evaluation apparatus according to claim 2, wherein
the measurement unit measures the number of characters of each of the model translated texts.

5. The translation evaluation apparatus according to claim 2, wherein
the measurement unit measures the number of constituent words that form each of the model translated texts.

6. The translation evaluation apparatus according to claim 2, the measurement unit measures the number of times a specific word is included within constituent words that form each of the model translated texts.

7. A translation evaluation method for evaluating the quality of a translated text that is a translation of an original text, comprising:
a parallel translation linking step in which at least one model translated text of a base original text is linked to create a linked model translated text, the at least one model translated text being stored in association with respective base original texts that are used as a basis for translation evaluation in a parallel translation storage unit, and in which the base original texts associated with the model translated texts that form the linked model translated text are linked to create a linked original text;
an evaluation target translated text input step in which at least one evaluation target translated text that is to be evaluated and that correspond with the base original text is input;
a linked evaluation target translated text creation step in which at least one evaluation target translated text that is associated with the base original texts that form the linked original text is linked to create a linked evaluation target translated text; and
a translation evaluation step in which the translation quality of the evaluation target translated text is evaluated by comparing the linked evaluation target translated text and the linked model translated text.

8. The translation evaluation method according to claim 7, wherein
the parallel translation linking step further comprises:
a measurement step for measuring the length of each of the model translated texts; and
a linking ID assigning step for assigning a single linking ID to the model translated texts that form the linked model translated text, the linking ID being the same for each model translated text in the linked model translated text, wherein
the linking ID assigning step assigns the linking ID to the model translated texts such that the linked model translated text has a length that is equal to or more than a determined length.

9. The translation evaluation method according to claim 8, further comprising:
a storing step for storing, in an associated manner, the base original text, the respective model translated texts of the base original text, and the evaluation target translated texts of the base original text, and the linking ID in a translation evaluation storage unit.

10. The translation evaluation method according to claim 8, wherein
in the measurement step, the number of characters of each of the model translated texts is measured.

11. The translation evaluation method according to claim 8, wherein
in the measurement step, the number of constituent words that form each of the model translated texts is measured.

12. The translation evaluation method according to claim 8, wherein
in the measurement step, the number of times a specific word is included within constituent words that form each of the model translated texts is measured.

13. A computer program that comprises instructions that command a computer to function as a translation evaluation apparatus that evaluates the quality of a translated text that is a translation of an original text, the computer program comprising:
a parallel translation storage module that stores, in an associated manner, base original texts that are used as a basis for translation evaluation, and respective model translated texts of the base original texts;
a parallel translation linking module that links at least one of the model translated texts to create a linked model translated text, and links the base original texts that are associated with the model translated texts that form the linked model translated text to create a linked original text;
an evaluation target translated text input module that is used to input at least one evaluation target translated text that is to be evaluated and that correspond with the base original text; and
a translation evaluation module that links the at least one evaluation target translated text that is associated with the base original texts that form the linked original text to create a linked evaluation target translated text, and compares the linked evaluation target translated text and the linked model translated text to evaluate the translation quality of the evaluation target translated text.
